(19) United States
(12) Patent Application Publication
(10) Pub. No.: US 2026/0108843 A1
(43) Pub. Date: Apr. 23, 2026

(54) CARBON DIOXIDE ABSORBENT CONTAINING IONIC MATERIAL CONTAINING CYCLIC AMMONIUM CATION AND HYDROXIDE ANION, AND CARBON DIOXIDE SEPARATION METHOD USING THE SAME

(71) Applicant: SK Innovation Co., Ltd., Seoul (KR)

(72) Inventors: Ji Su KIM, Daejeon (KR); Il Gu JUNG, Daejeon (KR); Eun Joon PARK, Daejeon (KR); Ji Su JEONG, Daejeon (KR); Sang Hyup SEO, Daejeon (KR); Lim Ok PYUN, Daejeon (KR)

(21) Appl. No.: 19/365,189

(22) Filed: Oct. 22, 2025

(30) Foreign Application Priority Data
Oct. 23, 2024 (KR) 10-2024-0145516

(51) Int. Cl. B01D 53/14; B01J 20/22; B01J 20/34

(52) U.S. Cl. CPC B01D 53/1475; B01D 53/1425; B01J 20/22; B01J 20/3425; B01J 20/3483; B01D 2252/20442; B01D 2252/30; B01D 2257/504

(57) ABSTRACT

The embodiments of the present disclosure relate to a carbon dioxide absorbent containing an ionic material containing a cyclic ammonium cation and a hydroxide anion. The carbon dioxide absorbent according to an embodiment contains a hydroxide anion having a small molecular weight and high basicity, such that absorption performance per unit volume of the absorbent may be effectively improved. Further, the carbon dioxide absorbent according to an embodiment is soluble in water and thus may not cause layer separation problems.

### CROSS-REFERENCE TO RELATED APPLICATIONS

This patent application claims priority under 35 U.S.C. § 119 to Korean Patent Application No. 10-2024-0145516, filed on Oct. 23, 2024, the disclosure of which is incorporated herein by reference in its entirety.

### TECHNICAL FIELD

The embodiments of the present disclosure generally relate to a carbon dioxide absorbent containing an ionic material containing a cyclic ammonium cation and a hydroxide anion, and a carbon dioxide separation method using the same.

### BACKGROUND

Energy use is increasing worldwide due to the rapid progress in economic development and industrialization, and accordingly, the use of fossil fuels, which are the main source of energy, is also increasing. Global warming issues closely related to energy use are a global concern. Carbon dioxide (CO₂) accounts for the highest proportion of the major greenhouse gases and is mostly produced in burning fossil fuels for producing energy.

Since the carbon dioxide produced as such is controllable, a technology to remove carbon dioxide is receiving great attention. A method to be applied to combustion exhaust gas during a process of capturing carbon dioxide is largely divided into an absorption method, an adsorption method, and a membrane separation method according to the separation characteristics. Among them, the most actively used method is an absorption method, and the absorption method is divided into a physical absorption method and a chemical absorption method. According to the chemical absorption method, aqueous solutions of amines such as monoethanolamine (MEA), N-methyldiethanolamine (MDEA), and diethanolamine (DEA) have been most widely used, and many studies on synthesis of an ionic material in which a cation and an anion are combined and its use as an absorbent have been conducted.

### SUMMARY

An embodiment of the present disclosure is directed to providing a carbon dioxide absorbent containing an ionic material.

Another embodiment of the present disclosure is directed to providing a carbon dioxide separation method using the carbon dioxide absorbent containing an ionic material.

According to embodiments of the present disclosure, a carbon dioxide absorbent is provided which contains an ionic material containing a cyclic ammonium cation represented by the following Chemical Formula 1 and a hydroxide anion:

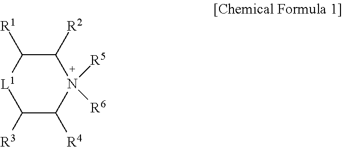

wherein
R¹ to R⁴ are each independently —H, a C₁₋₂₀ alkyl group, a C₁₋₂₀ alkoxy group, a C₁₋₁₀ alkoxy C₁₋₁₀ alkyl group, a C₅₋₂₀ cycloalkyl group, or a 5-membered to 20-membered heterocycloalkyl group; R⁵ and R⁶ are each independently —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group; L¹ is a single bond, —O—, —NR⁷—, or a C₁₋₈ alkylene group; R⁷ is —H or a C₁₋₁₀ alkyl group, or R⁷ may be bonded to R⁵ to form a ring; and the C₁₋₂₀ alkyl group, the C₁₋₂₀ alkoxy group, the C₁₋₁₀ alkoxy C₁₋₁₀ alkyl group, the C₅₋₂₀ cycloalkyl group, and the 5-membered to 20-membered heterocycloalkyl group of R¹ to R⁷ may each independently be substituted with a halogen group, —OH, —NH₂, or —NO₂.

In an embodiment, in Chemical Formula 1, R¹ to R⁴ are each independently —H, a C₁₋₁₀ alkyl group, a C₁₋₁₀ alkoxy group, a C₁₋₅ alkoxy C₁₋₅ alkyl group, a C₅₋₁₀ cycloalkyl group, or a 5-membered to 10-membered heterocycloalkyl group; R⁵ and R⁶ are each independently —H, a C₁₋₁₀ alkyl group, a C₁₋₅ alkoxy C₁₋₅ alkyl group, a C₅₋₁₀ cycloalkyl group, or a 5-membered to 10-membered heterocycloalkyl group; L¹ is a single bond, —O—, —NR⁷—, or a C₁₋₅ alkylene group; R⁷ is —H or a C₁₋₅ alkyl group, or R⁷ may be bonded to R⁵ to form a ring; and the C₁₋₁₀ alkyl group, the C₁₋₁₀ alkoxy group, the C₁₋₅ alkoxy C₁₋₅ alkyl group, the C₅₋₁₀ cycloalkyl group, and the 5-membered to 10-membered heterocycloalkyl group of R¹ to R⁷ may each independently be substituted with a halogen group, —OH, —NH₂, or —NO₂.

In an embodiment, the cyclic ammonium cation may be represented by the following Chemical Formula 2:

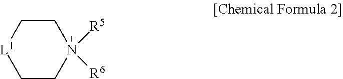

wherein
R⁵ and R⁶ are each independently —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group; L¹ is a single bond, —O—, —NR⁷—, or a C₁₋₈ alkylene group; R⁷ is —H or a C₁₋₁₀ alkyl group, or R⁷ may be bonded to R⁵ to form a ring; and the C₁₋₁₀ alkyl group, the C₁₋₂₀ alkyl group, the C₁₋₁₀ alkoxy C₁₋₁₀ alkyl group, the C₅₋₂₀ cycloalkyl group, and the 5-membered to 20-membered heterocycloalkyl group of R⁵ to R⁷ may each independently be substituted with a halogen group, —OH, —NH₂, or —NO₂.

In an embodiment, in Chemical Formula 2, R⁵ and R⁶ are each independently a C₁₋₁₀ alkyl group, a C₁₋₅ alkoxy C₁₋₅ alkyl group, a C₅₋₁₀ cycloalkyl group, and a 5-membered to 10-membered heterocycloalkyl group; L¹ is a single bond, —O—, —NR⁷—, or a C₁₋₈ alkylene group; R⁷ is —H or a C₁₋₅ alkyl group; and the C₁₋₁₀ alkyl group, the C₁₋₅ alkoxy C₁₋₅ alkyl group, the C₅₋₁₀ cycloalkyl group, and the 5-membered to 10-membered heterocycloalkyl group of R⁵ to R⁷ may each independently be substituted with —OH, —NH₂, or —NO₂.

In an embodiment, in Chemical Formula 2, R⁵ and R⁶ are each independently a C₁₋₅ alkyl group or a C₁₋₃ alkoxy C₁₋₃ alkyl group; L¹ is —O— or a methylene group; and the C₁₋₅ alkyl group and the C₁₋₃ alkoxy C₁₋₃ alkyl group of R⁵ and R⁶ may each independently be substituted with —OH.

In an embodiment, the cyclic ammonium cation may be one selected from the group consisting of compounds

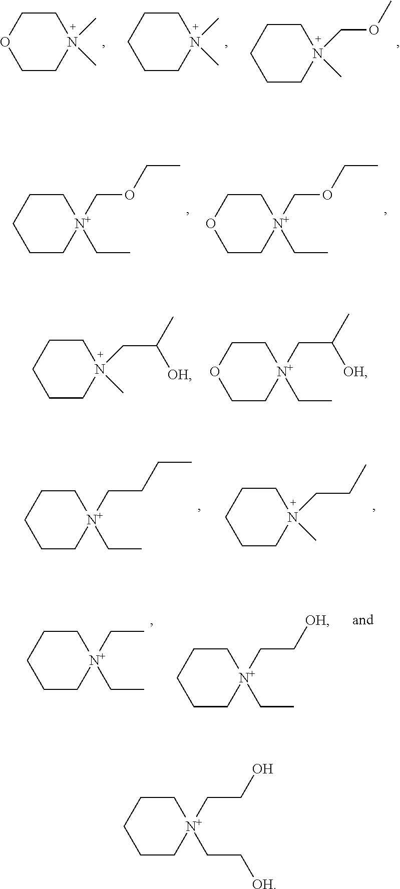

In an embodiment, the carbon dioxide absorbent may further contain water.

In an embodiment, the carbon dioxide absorbent may further contain one or more solvents other than the water.

In an embodiment, the solvent may contain an amine-based compound.

In an embodiment, the amine-based compound may include one or more selected from the group consisting of monoethanolamine (MEA), N-methyldiethanolamine (MDEA), diethanolamine (DEA), triethanolamine (TEA), 2-amino-2-methyl-1-propanol (AMP), and piperazine (PZ).

In an embodiment, the ionic material may be contained in an amount of 5 wt % to 50 wt % with respect to a total weight of the carbon dioxide absorbent.

In an embodiment, the water may be contained in an amount of 30 wt % to 90 wt % with respect to a total weight of the carbon dioxide absorbent.

In an embodiment, the amine-based compound may be contained in an amount of 10 wt % to 50 wt % with respect to a total weight of the carbon dioxide absorbent.

According to another embodiment, a carbon dioxide separation method is provided which includes bringing the carbon dioxide absorbent according to an embodiment of the present disclosure into contact with a mixture containing carbon dioxide under a temperature condition of 20° C. to 80° C.

In an embodiment, the carbon dioxide separation method may further include desorbing the carbon dioxide attached to the carbon dioxide absorbent. The desorbing of the carbon dioxide may include performing a heat treatment on the carbon dioxide absorbent under a temperature condition of 70° C. to 150° C. for 30 minutes to 250 minutes.

In an embodiment, in the carbon dioxide separation method, the bringing of the carbon dioxide absorbent into contact with the mixture and the desorbing of the carbon dioxide may be sequentially repeated to continuously separate the carbon dioxide.

Further, provided is a carbon dioxide separation method which comprises: contacting a mixture containing carbon dioxide with a carbon dioxide absorbent; absorbing the carbon dioxide into the carbon dioxide absorbent; desorbing the absorbed carbon dioxide attached to the carbon dioxide absorbent, wherein the absorbing and desorbing operations are performed sequentially and repeatedly to separate the carbon dioxide from the mixture, wherein the carbon dioxide absorbent includes an ionic material containing a cyclic ammonium cation and a hydroxide anion having a small molecular weight and high basicity, and wherein the carbon dioxide absorbent is soluble in water.

Other features, aspects, and advantages of the embodiments of the present disclosure will become apparent from the following detailed description, the drawings, and the claims.

### BRIEF DESCRIPTION OF THE DRAWINGS

FIG. 1 is a flow chart illustrating the carbon dioxide separation method according to the present disclosure.

### DETAILED DESCRIPTION

Embodiments described in the present specification may be modified in various different forms, and the technology according to one embodiment may not be limited to the embodiments described below. Furthermore, throughout the specification, unless explicitly described to the contrary, “comprising”, “including”, “containing”, or “having” any components will be understood to imply further inclusion of other components rather than the exclusion of any other components, and does not exclude elements, materials, or processes which are not further listed.

A numerical range used in the present specification includes upper and lower limits and all values within these limits, increments logically derived from a form and span of a defined range, all double limited values, and all possible combinations of the upper and lower limits in the numerical range defined in different forms. As an example, when a composition content is limited to 10% to 80% or 20% to 50%, a numerical range of 10% to 50% or 50% to 80% should also be interpreted as described in the present specification. Unless otherwise specifically defined in the present specification, values out of the numerical range that may occur due to experimental errors or rounded values also fall within the defined numerical range.

Hereinafter, in the present specification, unless otherwise specifically defined, “about” may be considered a value within 30%, 25%, 20%, 15%, 10%, 5%, 3%, 2%, 1%, or 0.5% of a stated value.

The term “alkylene group” as used in the present specification refers to a linear or branched diradical of a carbon saturated bond, and may be substituted with an arbitrary substituent.

The term “alkyl group” as used in the present specification refers to a linear or branched radical of a carbon saturated bond, and may be substituted with an arbitrary substituent.

The term “cycloalkyl group” as used in the present specification refers to a carbon ring radical of a carbon saturated bond, and may be substituted with an arbitrary substituent.

The term “heterocycloalkyl group” as used in the present specification refers to a ring radical containing one or more heteroatoms selected from the group consisting of oxygen (O), nitrogen (N), and sulfur (S), and may be substituted with an arbitrary substituent. For example, the “5-membered to 20-membered heterocycloalkyl group” means that the number of carbon, oxygen, nitrogen, and/or sulfur atoms forming the ring is 5 to 20 excluding the number of substituent atoms such as hydrogen atoms and the like substituted on carbon atoms.

Hereinafter, embodiments of the present disclosure will be described in detail with reference to the accompanying drawings. However, the description is merely illustrative and the embodiments are not limited to the specific embodiments described.

An embodiment provides a carbon dioxide absorbent containing an ionic material containing a cyclic ammonium cation represented by the following Chemical Formula 1 and a hydroxide anion:

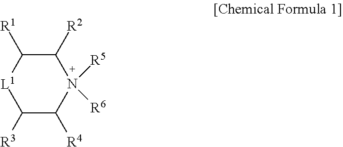

wherein
R¹ to R⁴ may each independently be —H, a C₁₋₂₀ alkyl group, a C₁₋₂₀ alkoxy group, a C₁₋₁₀ alkoxy C₁₋₁₀ alkyl group, a C₅₋₂₀ cycloalkyl group, or a 5-membered to 20-membered heterocycloalkyl group; R⁵ and R⁶ may each independently be —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group; L¹ may be a single bond, —O—, —NR⁷—, or a C₁₋₈ alkylene group; R⁷ may be —H or a C₁₋₁₀ alkyl group or R⁷ may be bonded to R⁵ to form a ring; and the C₁₋₂₀ alkyl group, the C₁₋₂₀ alkoxy group, the C₁₋₁₀ alkoxy C₁₋₁₀ alkyl group, the C₅₋₂₀ cycloalkyl group, and the 5-membered to 20-membered heterocycloalkyl group of R¹ to R⁷ may each independently be substituted with a halogen group, —OH, —NH₂, or —NO₂.

The carbon dioxide absorbent according to an embodiment contains an ionic material obtained by combining an ammonium cation with a hydroxide anion (—OH) having a high basicity and a significantly small molecular weight (e.g., potassium hydroxide, sodium hydroxide) compared to an anion (an acetate-based anion, a phosphate-based anion, a halogen anion, a fluorine-based anion (BF₄⁻, PF₆⁻, or the like), NO₃⁻, or the like) used in a carbon dioxide absorbent of the related art, such that the carbon dioxide capture (absorption) capacity per unit volume of the absorbent may be effectively increased.

In addition, since all ionic materials contained in the carbon dioxide absorbent according to an embodiment are soluble in water and, thus, dissolve in a solvent before and after carbon dioxide absorption, layer separation may not occur. Moreover, an anion used in the related art, such as a phenolate anion, is converted to phenol by receiving a proton during a process in which the carbon dioxide absorbent absorbs carbon dioxide, and phenol does not dissolve in water, which causes the layer separation of the absorbent. The layer separation may cause instability of a flow rate of the absorbent within a continuous circulation apparatus, and an additional process such as adding an additional solvent is required to eliminate the layer separation, which is not economically effective compared to the carbon dioxide absorbent according to an embodiment of the present disclosure.

In addition, the absorbent according to an embodiment significantly solves the problem of an increase in viscosity after absorption compared to before carbon dioxide absorption, thereby enabling carbon dioxide absorption and desorption to be performed significantly efficiently. In a case where phenol, carbamate, or carbonate is produced using the carbon dioxide absorbent of the related art, as a viscosity of a reaction solution increases, the efficiency of the continuous carbon dioxide absorption reaction is reduced, and high temperature conditions are required for a long period of time when desorbing carbon dioxide again after carbon dioxide absorption. However, the carbon dioxide absorbent according to an embodiment may be effective in carbon dioxide absorption and desorption since the viscosity does not significantly increase after the carbon dioxide capture.

In an embodiment, R¹ to R⁴ may each independently be —H, a C₁₋₁₅ alkyl group, a C₁₋₁₀ alkyl group, a C₁₋₈ alkyl group, a C₁₋₅ alkyl group, a C₁₋₃ alkyl group, a methyl group, an ethyl group, a C₁₋₁₅ alkoxy group, a C₁₋₁₀ alkoxy group, a C₁₋₈ alkoxy group, a C₁₋₅ alkoxy group, a C₁₋₃ alkoxy group, a methoxy group, an ethoxy group, a C₁₋₈ alkoxy C₁₋₈ alkyl group, a C₁₋₅ alkoxy C₁₋₅ alkyl group, a C₁₋₃ alkoxy C₁₋₃ alkyl group, an ethoxymethyl group, a methoxymethyl group, a C₅₋₁₅ cycloalkyl group, a C₅₋₁₀ cycloalkyl group, a C₅₋₈ cycloalkyl group, a C₆₋₈ cycloalkyl group, a cyclopentyl group, a cyclohexyl group, or a 5-membered to 15-membered, 5-membered to 10-membered, 5-membered to 8-membered, or 6-membered to 8-membered heterocycloalkyl group.

In an embodiment, R⁵ and R⁶ may each independently be —H, a C₁₋₁₅ alkyl group, a C₁₋₁₀ alkyl group, a C₁₋₈ alkyl group, a C₁₋₅ alkyl group, a C₁₋₃ alkyl group, a methyl group, an ethyl group, a C₁₋₈ alkoxy C₁₋₈ alkyl group, a C₁₋₅ alkoxy C₁₋₅ alkyl group, a C₁₋₃ alkoxy C₁₋₃ alkyl group, an ethoxymethyl group, a methoxymethyl group, a C₅₋₁₅ cycloalkyl group, a C₅₋₁₀ cycloalkyl group, a C₅₋₈ cycloalkyl group, a C₆₋₈ cycloalkyl group, a cyclopentyl group, a cyclohexyl group, or a 5-membered to 15-membered, 5-membered to 10-membered, 5-membered to 8-membered, or 6-membered to 8-membered heterocycloalkyl group.

In an embodiment, L¹ may be a single bond, —O—, —NR⁷—, a C₁₋₈ alkylene group, a C₁₋₃ alkylene group, a methylene group, or an ethylene group, and R⁷ may be —H, a C₁₋₁₀ alkyl group, a C₁₋₈ alkyl group, a C₁₋₅ alkyl group, a C₁₋₃ alkyl group, a methyl group, or an ethyl group, or R⁷ may be bonded to R⁵ to form a ring. In this case, when R⁷ is bonded to R⁵ to form a bicyclic ring, the cyclic ammonium cation may be represented by the following Chemical Formula 3:

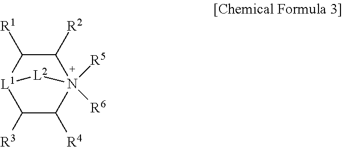

wherein the substituents R¹ to R⁶ and L¹ are as defined in Chemical Formula 1 or Chemical Formula 2, and L² may be a C₁₋₅ alkylene group, a C₁₋₃ alkylene group, a C₁₋₂ alkylene group, a methylene group, or an ethylene group.

In an embodiment, the alkyl group, the alkoxy group, the alkoxyalkyl group, the cycloalkyl group, and the heterocycloalkyl group of R¹ to R⁷ may each independently be substituted with an arbitrary substituent, and may be substituted with, for example, one or more halogen groups selected from the group consisting of I, Br, Cl, and F, —OH, —NH₂, or —NO₂.

In addition, in an embodiment, R¹ to R⁴ may each independently be —H, a C₁₋₁₀ alkyl group, a C₁₋₁₀ alkoxy group, a C₁₋₅ alkoxy C₁₋₅ alkyl group, a C₅₋₁₀ cycloalkyl group, or a 5-membered to 10-membered heterocycloalkyl group; R⁵ and R⁶ may each independently be —H, a C₁₋₁₀ alkyl group, a C₁₋₅ alkoxy C₁₋₅ alkyl group, a C₅₋₁₀ cycloalkyl group, or a 5-membered to 10-membered heterocycloalkyl group; L¹ may be a single bond, —O—, —NR⁷—, or a C₁₋₅ alkylene group; R⁷ may be —H or a C₁₋₅ alkyl group, or R⁷ may be bonded to R⁵ to form a ring; and the C₁₋₁₀ alkyl group, the C₁₋₁₀ alkoxy group, the C₁₋₅ alkoxy C₁₋₅ alkyl group, the C₅₋₁₀ cycloalkyl group, and the 5-membered to 10-membered heterocycloalkyl group of R¹ to R⁷ may each independently be substituted with a halogen group, —OH, —NH₂, or —NO₂.

In an embodiment, the cyclic ammonium cation may be represented by the following Chemical Formula 2:

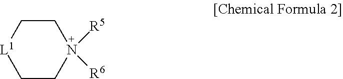

wherein
R⁵ and R⁶ may each independently be —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group; L¹ is a single bond, —O—, —NR⁷—, or a C₁₋₈ alkylene group; R⁷ is —H or a C₁₋₁₀ alkyl group, or R⁷ may be bonded to R⁵ to form a ring; and the C₁₋₁₀ alkyl group, the C₁₋₂₀ alkyl group, the C₁₋₁₀ alkoxy C₁₋₁₀ alkyl group, the C₅₋₂₀ cycloalkyl group, and the 5-membered to 20-membered heterocycloalkyl group of R⁵ to R⁷ may each independently be substituted with a halogen group, —OH, —NH₂, or —NO₂.

In an embodiment, the substituents R⁵, R⁶, and L¹ in Chemical Formula 2 may be as defined in Chemical Formula 1, and specifically, in an embodiment, R⁵ and R⁶ may each independently be a C₁₋₁₀ alkyl group, a C₁₋₅ alkoxy C₁₋₅ alkyl group, a C₅₋₁₀ cycloalkyl group, or a 5-membered to 10-membered heterocycloalkyl group; L¹ may be a single bond, —O—, —NR⁷—, or a C₁₋₈ alkylene group; R⁷ may be —H or a C₁₋₅ alkyl group; and the C₁₋₁₀ alkyl group, the C₁₋₅ alkoxy C₁₋₅ alkyl group, the C₅₋₁₀ cycloalkyl group, and the 5-membered to 10-membered heterocycloalkyl group of R⁵ to R⁷ may each independently be substituted with —OH, —NH₂, or —NO₂.

Alternatively, in an embodiment, in Chemical Formula 2, R⁵ and R⁶ are each independently a C₁₋₅ alkyl group or a C₁₋₃ alkoxy C₁₋₃ alkyl group; L¹ is —O— or a methylene group; and the C₁₋₅ alkyl group and the C₁₋₃ alkoxy C₁₋₃ alkyl group of R⁵ and R⁶ may each independently be substituted with —OH.

In an embodiment, the cyclic ammonium cation may be

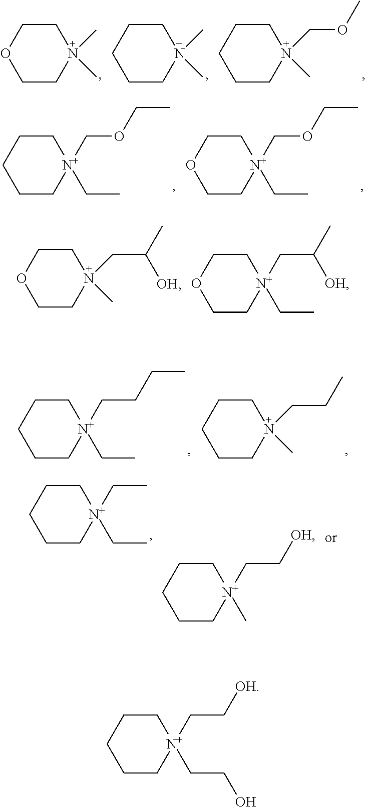

In an embodiment, the carbon dioxide absorbent may further contain water as a solvent. Alternatively, in an embodiment, the carbon dioxide absorbent may further contain one or more solvents other than water together with water as a solvent, for example, an amine-based compound. In an embodiment, the amine-based compound may include, but is not limited to, monoethanolamine (MEA), N-methyldiethanolamine (MDEA), diethanolamine (DEA), triethanolamine (TEA), 2-amino-2-methyl-1-propanol (AMP), and/or piperazine (PZ). Alternatively, the carbon dioxide absorbent may further contain a non-aqueous solvent, for example, ethylene glycol, propylene glycol, methyl glycol, methyl isopropyl carboxylate, methyl diethyl carboxylate, triethylene glycol, dimethyl sulfonate, and/or diethyl sulfonate.

In an embodiment, the ionic material may be contained in an amount of 5 wt % to 50 wt %, 5 wt % to 40 wt %, 10 wt % to 50 wt %, 10 wt % to 40 wt %, 20 wt % to 50 wt %, 20 wt % to 40 wt %, 25 wt % to 40 wt, 25 wt % to 30 wt, about 25 wt, or about 30 wt, with respect to a total weight of the carbon dioxide absorbent, but is not limited to the above range.

In an embodiment, in a case where the carbon dioxide absorbent contains water as a solvent, the water may be contained in an amount of 30 wt % to 90 wt % or 40 wt % to 80 wt % with respect to the total weight of the carbon dioxide absorbent, but is not limited to the above range. In an embodiment, in a case where the carbon dioxide absorbent contains only water as a solvent, the water may be contained in an amount of 50 wt % to 90 wt %, 50 wt % to 80 wt %, 60 wt % to 80 wt %, or about 70 wt %, but is not limited to the above range. In an embodiment, in a case where the carbon dioxide absorbent further contains a solvent other than water as a solvent, the water may be contained in an amount of 30 wt % to 60 wt %, 30 wt % to 50 wt %, 40 wt % to 50 wt %, or about 45 wt %, but is not limited to the above range.

In an embodiment, in a case where the carbon dioxide absorbent further contains a solvent other than water, the solvent other than water may be contained in an amount of 10 wt % to 50 wt %, 10 wt % to 40 wt %, 20 wt % to 50 wt %, 20 wt % to 40 wt %, 25 wt % to 40 wt %, 25 wt % to 30 wt %, about 25 wt %, or about 30 wt %, with respect to the total weight of the carbon dioxide absorbent, but is not limited to the above range, and the solvent other than water may be, for example, an amine-based compound.

In an embodiment, a capture (or absorption) performance (unit: mmol/mL) of the carbon dioxide absorbent may be 0.5 or more, 0.9 or more, 1.0 or more, 1.5 or more, 1.8 or more, 3.0 or more, 3.5 or more, 4.0 or more, or 4.3 or more. In this case, an upper limit thereof may be 2.0 or less, 3.0 or less, 4.8 or less, 5.0 or less, or 5.5 or less. The capture performance refers to the number of moles of carbon dioxide captured per unit volume of the carbon dioxide absorbent.

In an embodiment, a capture (or absorption) equivalent (unit: mol/mol) of the carbon dioxide absorbent may be 0.7 or more, 1.0 or more, 1.3 or more, 1.8 or more, or 2.0 or more. In this case, an upper limit thereof may be 4.0 or less, 3.0 or less, or 2.5 or less. The capture equivalent refers to the number of moles of carbon dioxide captured per unit mole of the ionic material and the amine-based compound in the carbon dioxide absorbent.

Another embodiment provides a carbon dioxide supply agent containing a compound formed by reacting carbon dioxide with the carbon dioxide absorbent.

Still another embodiment provides a carbon dioxide separation method which includes bringing the carbon dioxide absorbent according to an embodiment of the present disclosure into contact with a mixture containing carbon dioxide under a temperature condition of 20° C. to 80° C.

In an embodiment, the temperature condition may be, for example, 20° C. to 60° C., 30° C. to 60° C., 30° C. to 50° C., or about 40° C. In addition, bringing the carbon dioxide absorbent into contact with the mixture may be performed under a pressure condition of 0.1 bar to 2.0 bar, 0.5 bar to 2.0 bar, 0.5 bar to 1.5 bar, 0.7 bar to 1.3 bar, or 1.0 bar, but is not limited thereto.

The carbon dioxide separation method may further include desorbing carbon dioxide attached to the absorbent by performing a heat treatment on the carbon dioxide absorbent under conditions of a temperature of 70° C. to 150° C. and a N₂ flow of 100 cc/min to 300 cc/min for 30 minutes to 250 minutes. In this case, the temperature condition is not limited to the above range, and for example, the heat treatment may be performed at 80° C. to 130° C., 80° C. to 120° C., 80° C. to 110° C., 85° C. to 120° C., 85° C. to 110° C., or 90° C. to 110° C. In addition, the time condition is not limited to the above range, and for example, the heat treatment may be performed for 30 minutes to 210 minutes, 50 minutes to 210 minutes, 60 minutes to 250 minutes, 60 minutes to 200 minutes, or 60 minutes to 180 minutes. In addition, the N₂ flow condition is not limited to the above range, and for example, the heat treatment may be performed at 150 cc/min to 250 cc/min, 180 cc/min to 220 cc/min, or 200 cc/min.

In addition, the carbon dioxide separation method may be a method of continuously separating the carbon dioxide by sequentially repeating the contact with the carbon dioxide to absorb the carbon dioxide and the desorbing of the carbon dioxide attached to the absorbent. For example, the carbon dioxide separation method may involve a continuous process in which carbon dioxide is repeatedly absorbed through contact with the adsorbent and then desorbed from the absorbent.

The carbon dioxide separation method according to an embodiment may reduce a reduction rate of the absorbent after carbon dioxide desorption due to inhibition of decomposition of the carbon dioxide absorbent in the desorbing of the carbon dioxide under high temperature and basic conditions.

Accordingly, in the carbon dioxide separation method, the loss of the absorbent according to the number of processes is less than that of the carbon dioxide absorption method using the carbon dioxide absorbent of the related art, such that the amount of absorbent that needs to be replenished after each process may be reduced, and the process operation may be more economically effective.

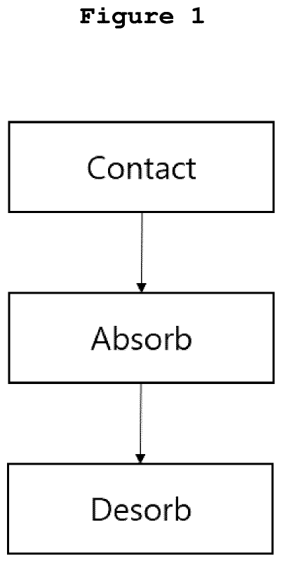

Referring to FIG. 1, provided is a carbon dioxide separation method which comprises: contacting a mixture containing carbon dioxide with a carbon dioxide absorbent; absorbing the carbon dioxide into the carbon dioxide absorbent; desorbing the absorbed carbon dioxide attached to the carbon dioxide absorbent, wherein the absorbing and desorbing operations are performed sequentially and repeatedly to separate the carbon dioxide from the mixture, wherein the carbon dioxide absorbent includes an ionic material containing a cyclic ammonium cation and a hydroxide anion having a small molecular weight and high basicity, and wherein the carbon dioxide absorbent is soluble in water.

Hereinafter, examples and experimental examples will be described in detail. However, the examples and the experimental examples described below are only illustrative of some embodiments of the present disclosure, and the technology described in the present specification is not construed as being limited thereto. Furthermore, the embodiments may be combined to form additional embodiments.

### <Preparation Examples 1 and 2> Preparation of Ionic Materials

133.6 mmol of an iodide of each cation in Table 1, 133.6 mmol of silver(I) oxide, and 80 mL of water were added, and then, stirring was performed at room temperature for 4 hours. The produced silver iodide solid was removed by filtration, and an excess of water was dried under vacuum at 50° C., thereby obtaining an ionic material in an aqueous solution state. The ¹H NMR (the proton Nuclear Magnetic Resonance) of the obtained ionic material was measured. The results thereof are shown in Table 1.

### <Preparation Example 3> Preparation of Ionic Material

133.6 mmol of a chloride of the cation in Table 1, 140.3 mmol of potassium hydroxide, and 80 mL of ethanol were added, and then, stirring was performed at room temperature for 4 hours. The produced potassium chloride solid was removed by filtration, an excess of water was added, and then, ethanol was removed by vacuum drying at 50° C., thereby obtaining an ionic material in an aqueous solution state. The ¹H NMR of the obtained ionic material was measured. The results thereof are shown in Table 1.

### <Preparation Example 4> Preparation of Ionic Material

133.6 mmol of N-methyl piperidine, 140.3 mmol of propylene oxide, and 80 mL of ethanol were added, and then, stirring was performed at room temperature for 4 hours. An excess of water was added, and then, ethanol was removed by vacuum drying at 50° C., thereby obtaining an ionic material in an aqueous solution state. The ¹H NMR of the obtained ionic material was measured. The results thereof are shown in Table 1.

### <Preparation Example 5> Preparation of Ionic Material

133.6 mmol of a bromide of the cation in Table 1, 133.6 mmol of silver (I) oxide, and 80 mL of water were added, and then, stirring was performed at room temperature for 4 hours. The produced silver bromide solid was removed by filtration, and an excess of water was dried under vacuum at 50° C., thereby obtaining an ionic material in an aqueous solution state. The ¹H NMR of the obtained ionic material was measured. The results thereof are shown in Table 1.

### <Preparation Example 6> Preparation of Ionic Material

133.6 mmol of ethyl sulfate salt of the cation in Table 1 and 6.68 mmol of sulfuric acid, and 80 mL of water were added, and then, refluxing was performed while performing stirring at 110° C. for 16 hours. An excess of ethanol was added, water was removed by vacuum drying at 50° C., 140.3 mmol of potassium hydroxide and 80 mL of ethanol were added, and then, stirring was performed at room temperature for 4 hours. The produced potassium sulfate solid was removed by filtration, an excess of water was added, and then, ethanol was removed by vacuum drying at 50° C., thereby obtaining an ionic material in an aqueous solution state. The 1H NMR of the obtained ionic material was measured. The results thereof are shown in Table 1.

### <Preparation Examples 7 and 8> Preparation of Ionic

133.6 mmol of a chloride of each cation in Table 1, 140.3 mmol of potassium hydroxide, and 80 mL of ethanol were added, and then, stirring was performed at room temperature for 4 hours. The produced potassium chloride solid was removed by filtration, an excess of water was added, and then, ethanol was removed by vacuum drying at 50° C., thereby obtaining an ionic material in an aqueous solution state. The ¹H NMR of the obtained ionic material was measured. The results thereof are shown in Table 1.

TABLE 1

| PreparationIonic | Ionic material | | |
|---|---|---|---|
| Example No. | Cation | Anion | ¹H NMR |
| 1 | 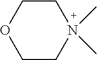 | —OH | ¹H NMR (500 MHz), D₂O, 25° C.: δ = 4.10 (t, 4H), 3.52 (t, 4H), 3.15 (s, 6H) |
| 2 | 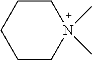 | —OH | ¹H NMR (500 MHz), D₂O, 25° C.: δ = 3.25 (t, 4H), 3.03 (s, 6H), 1.80 (br, 4H), 1.55 (m, 2H) |
| 3 | 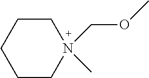 | —OH | ¹H NMR (500 MHz), D₂O, 25° C.: δ = 4.63 (s, 2H), 3.69 (s, 3H), 3.25~3.38 (m, 4H), 3.01 (s, 3H), 1.90 (br, 4H), 1.57~1.70 (m, 2H) |
| 4 | 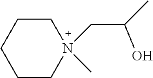 | —OH | ¹H NMR (500 MHz), D₂O, 25° C.: δ = 4.33 ( quintet, 1H), 3.43~3.22 (m, 6H), 3.10~3.04 (m, 3H), 1.88~1.72 (m, 4H), 1.59~1.56 (m, 2H), 1.16 (d, 3H) |
| 5 | 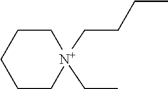 | —OH | ¹H NMR (500 MHz), D₂O, 25° C.: δ = 3.33~3.45 (m, 8H), 1.87 (br, 4H), 1.66~1.73(m, 4H), 1.39~1.45 (m, 2H), 1.27 (t, 3H), 0.98 (t, 3H) |
| 6 | 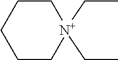 | —OH | ¹H NMR (500 MHz), D₂O, 25° C.: δ = 3.32~3.41 (m, 8H), 1.85 (br, 4H), 1.67~1.75 (m, 2H), 1.29 (t, 6H) |
| 7 | 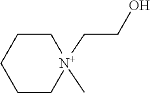 | —OH | ¹H NMR (500 MHz), D₂O, 25° C.: δ = 4.06 (s, 2H), 3.53 (t, 2H), 3.48~3.38 (m, 4H), 3.14 (s, 3H), 1.91~1.89 (m, 4H), 1.69~1.65 (m, 2H) |
| 8 | 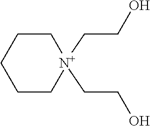 [SMILES: OCC[N+]1(CCO)CCCCC1] | —OH | ¹H NMR (500 MHz), D₂O, 25° C.: δ = 4.05 (t, 4H), 3.65 (t, 4H), 3.52 (t, 4H), 1.93~1.91 (m, 4H), 1.72~1.67 (m, 2H) |

### <Preparation Example 9> Preparation of Ionic Material

133.6 mmol of N-methyl piperidine, 133.6 mmol of methyl iodide, and 40 mL of tetrahydrofuran were added, and then, stirring was performed at room temperature for 18 hours. Tetrahydrofuran was removed by vacuum drying at 50° C. for 15 hours, and an ionic material in a solid state was obtained. The ¹H NMR of the obtained ionic material was measured. The results thereof are shown in Table 2.

### <Preparation Examples 10 and 11> Preparation of Ionic Materials

133.6 mmol of the ionic material of Preparation Example 2 in Table 1, 133.6 mmol of phenol or imidazole, and 40 mL of water were added, and then, stirring was performed at room temperature for 1 hour, thereby obtaining an ionic material in an aqueous solution state. The 1H NMR of the obtained ionic material was measured. The results thereof are shown in Table 2.

### <Preparation Examples 12 to 13> Preparation of Ionic Materials

133.6 mmol of the ionic material of Preparation Example 9 in Table 2, 133.6 mmol of silver(I) acetate or silver(I) tetrafluoroborate, and 40 mL of water were added, and then, stirring was performed at room temperature for 4 hours. The produced silver iodide solid was removed by filtration and an ionic material in an aqueous solution state was obtained. The 1H NMR of the obtained ionic material was measured. The results thereof are shown in Table 2.

### <Preparation Example 14> Preparation of Ionic Material

133.6 mmol of the ionic material of Preparation Example 2 in Table 1, 133.6 mmol of phosphoric acid, and 40 mL of water were added, and then, stirring was performed at room temperature for 1 hour, thereby obtaining an ionic material in an aqueous solution state. The 1H NMR of the obtained ionic material was measured. The results thereof are shown in Table 2.

TABLE 2

| Preparation | Ionic material | | |
|---|---|---|---|
| Example No. | Cation | Anion | ¹H NMR |
| 9 | 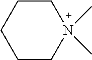 | I⁻ | ¹H NMR (500 MHz), D₂O, 25° C.: δ = 3.37 (t, 4H), 3.20 (s, 6H), 1.93 (br, 4H), 1.70~81 (m, 2H) |
| 10 | 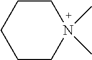 | 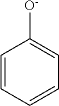 | ¹H NMR (500 MHz), D₂O, 25° C.: δ = 6.96 (t, 2H), 6.43 (d, 2H), 6.40 (d, 1H), 3.20 (t, 4H), 3.06 (s, 6H), 1.83 (br, 4H), 1.60 (quintet, 2H) |
| 11 | 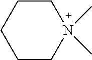 | 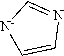 | ¹H NMR (500 MHz), D₂O, 25° C.: δ = 7.70 (s, 1H), 7.07 (s, 2H), 3.27 (t, 4H), 3.03 (s, 6H), 1.82 (br, 4H), 1.57~61 (m, 2H) |
| 12 | 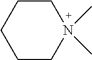 | 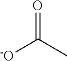 | ¹H NMR (500 MHz), D₂O, 25° C.: δ = 3.34 (t, 4H), 3.10 (s, 6H), 1.91 (s, 3H), 1.88 (br, 4H), 1.65 (quintet, 2H) |
| 13 | 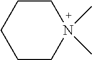 | BF₄⁻ | ¹H NMR (500 MHz), D₂O, 25° C.: δ = 3.38 (t, 4H), 3.14 (s, 6H), 1.93 (br, 4H), 1.70 (quintet, 2H) |
| 14 | 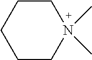 | 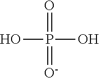 | ¹H NMR (500 MHz), D₂O, 25° C.: δ = 3.18 (t, 4H), 2.94 (s, 6H), 1.72 (br, 4H), 1.49 ( quintet, 2H) |

### <Examples 1 to 16> Preparation of Carbon Dioxide Absorbents

Carbon dioxide absorbents of Examples 1 to 16 containing the ionic materials and solvents of Preparation Examples 1 to 8 with the compositions shown in Table 3 were prepared. Specifically, the carbon dioxide absorbent was prepared by adding the ionic material and the solvent at wt % (based on the total weight of the carbon dioxide absorbent) shown in Table 3, regardless of the order of addition, and performing mixing at a temperature of about 30° C. for about 40 minutes.

TABLE 3

| Example No. | Ionic material (wt %) | Solvent (wt %) |
|---|---|---|
| 1 | Preparation Example 1 | Water (70 wt %) |
| | (30 wt %) | |
| 2 | Preparation Example 2 | Water (70 wt %) |
| | (30 wt %) | |
| 3 | Preparation Example 3 | Water (70 wt %) |
| | (30 wt %) | |
| 4 | Preparation Example 4 | Water (70 wt %) |
| | (30 wt %) | |
| 5 | Preparation Example 5 | Water (70 wt %) |
| | (30 wt %) | |
| 6 | Preparation Example 6 | Water (70 wt %) |
| | (30 wt %) | |
| 7 | Preparation Example 7 | Water (70 wt %) |
| | (30 wt %) | |
| 8 | Preparation Example 8 | Water (70 wt %) |
| | (30 wt %) | |
| 9 | Preparation Example 1 | Water (45 wt %), PZ |
| | (25 wt %) | (30 wt %) |
| 10 | Preparation Example 2 | Water (45 wt %), PZ |
| | (25 wt %) | (30 wt %) |
| 11 | Preparation Example 3 | Water (45 wt %), PZ |
| | (25 wt %) | (30 wt %) |
| 12 | Preparation Example 4 | Water (45 wt %), PZ |
| | (25 wt %) | (30 wt %) |
| 13 | Preparation Example 5 | Water (45 wt %), PZ |
| | (25 wt %) | (30 wt %) |
| 14 | Preparation Example 6 | Water (45 wt %), PZ |
| | (25 wt %) | (30 wt %) |
| 15 | Preparation Example 7 | Water (45 wt %), PZ |
| | (25 wt %) | (30 wt %) |
| 16 | Preparation Example 8 | Water (45 wt %), PZ |
| | (25 wt %) | (30 wt %) |

(PZ: piperazine)

### <Comparative Examples 1 to 12> Preparation of Carbon Dioxide Absorbents

Carbon dioxide absorbents of Comparative Examples 1 to 12 containing the ionic materials and solvents of Preparation Examples 9 to 14 with the compositions shown in Table 4 were prepared. Specifically, the carbon dioxide absorbent was prepared by adding the ionic material and the solvent at wt % (based on the total weight of the carbon dioxide absorbent) shown in Table 4, regardless of the order of addition, and performing mixing at a temperature of about 30° C. for about 40 minutes.

TABLE 4

| Comparative | | |
|---|---|---|
| Example No. | Ionic material (wt %) | Solvent (wt %) |
| 1 | Preparation Example 9 | Water (70 wt %) |
| | (30 wt %) | |
| 2 | Preparation Example 10 | Water (70 wt %) |
| | (30 wt %) | |
| 3 | Preparation Example 11 | Water (70 wt %) |
| | (30 wt %) | |
| 4 | Preparation Example 12 | Water (70 wt %) |
| | (30 wt %) | |
| 5 | Preparation Example 13 | Water (70 wt %) |
| | (30 wt %) | |
| 6 | Preparation Example 14 | Water (70 wt %) |
| | (30 wt %) | |
| 7 | Preparation Example 9 | Water (45 wt %), PZ |
| | (25 wt %) | (30 wt %) |
| 8 | Preparation Example 10 | Water (45 wt %), PZ |
| | (25 wt %) | (30 wt %) |
| 9 | Preparation Example 11 | Water (45 wt %), PZ |
| | (25 wt %) | (30 wt %) |
| 10 | Preparation Example 12 | Water (45 wt %), PZ |
| | (25 wt %) | (30 wt %) |
| 11 | Preparation Example 13 | Water (45 wt %), PZ |
| | (25 wt %) | (30 wt %) |
| 12 | Preparation Example 14 | Water (45 wt %), PZ |
| | (25 wt %) | (30 wt %) |

(PZ: piperazine)

### <Experimental Example 1> Carbon Dioxide Absorption Performance Evaluation

In order to evaluate the carbon dioxide absorption performance of each of the carbon dioxide absorbents according to the examples and the comparative examples, the carbon dioxide absorption performance was measured using a vapor liquid equilibrium (VLE) apparatus. As the vapor liquid equilibrium apparatus, an apparatus including a carbon dioxide storage cylinder (150 mL), a constant temperature water bath, a stainless steel absorption reactor (73 mL) equipped with a thermometer, an electronic pressure gauge, and a stirrer was used. At this time, the absorption performance was measured while maintaining the cylinder and the reactor at a constant temperature of 40° C. using a constant temperature water tank and a heating block, respectively. The measurement error ranges of the reactor were ±0.1° C. and ±0.01 bar.

The carbon dioxide absorption performance evaluation was specifically performed using the following method. First, the inside of each of the carbon dioxide storage cylinder and the absorption reactor was sufficiently replaced with nitrogen, and then, the carbon dioxide storage cylinder was filled with carbon dioxide and maintained at 1 bar and 40° C. Next, a carbon dioxide absorbent (6.0 g) solution according to each of the examples and the comparative examples was injected into the absorption reactor, the temperature was maintained at 40° C., a valve connecting the cylinder and the reactor was opened, and then, the pressure was measured after absorption equilibrium was reached. The equilibrium pressure was measured every 30 minutes, and the process was repeated until there was no pressure change between the cylinder and the reactor. Next, the ideal gas equation was used to calculate the number of moles of carbon dioxide captured according to pressure change.

The values obtained by dividing the calculated number of moles (mmol) of carbon dioxide captured by the volume (mL) of the carbon dioxide absorbent injected are shown in Tables 5 and 6. In addition, after evaluating the carbon dioxide absorption performance, the presence or absence of layer separation in the absorbent was visually observed and the results were shown together. X denotes that there is no layer separation present (absence of layer separation), and O denotes that there is a layer separation (presence of layer separation).

TABLE 5

| | Capture performance | Presence or absence |
|---|---|---|
| Example No. | (mmol/mL) | of layer separation |
| 1 | 2.16 | X |
| 2 | 2.32 | X |
| 3 | 1.83 | X |
| 4 | 1.60 | X |
| 5 | 1.61 | X |
| 6 | 2.03 | X |
| 7 | 1.79 | X |
| 8 | 1.63 | X |
| 9 | 4.64 | X |
| 10 | 4.68 | X |
| 11 | 4.45 | X |
| 12 | 4.21 | X |
| 13 | 4.33 | X |
| 14 | 4.36 | X |
| 15 | 4.42 | X |
| 16 | 4.29 | X |

TABLE 6

| Comparative | Capture performance | Presence or absence |
|---|---|---|
| Example No. | (mmol/mL) | of layer separation |
| 1 | 0.00 | X |
| 2 | 0.86 | ◯ |
| 3 | 1.47 | X |
| 4 | 0.03 | X |
| 5 | 0.00 | X |
| 6 | 0.00 | X |
| 7 | 3.39 | X |
| 8 | 4.07 | X |
| 9 | 3.93 | X |
| 10 | 3.21 | X |
| 11 | 3.05 | ◯ |
| 12 | 2.23 | Solid precipitation |

As can be confirmed through Tables 5 and 6, the carbon dioxide capture capacity values of Examples 1 to 8 which used only ionic materials are all 1.6 mmol-CO₂/mL-absorbent or more, showing the improved carbon dioxide absorption performance compared to Comparative Examples 1 to 6 which used only ionic materials. In addition, it can be seen that the carbon dioxide capture capacity values of Examples 9 to 16, in which an amine-based compound was additionally used in the solvent, are all 4.2 mmol-CO₂/mL-absorbent or more, showing the improved carbon dioxide absorption performance compared to Comparative Examples 7 to 12. In addition, since no layer separation is observed in all of the absorbents of the examples, there is no factor that causes the instability of the flow rate of the absorbent within the continuous circulation apparatus, and there is no need for a process of adding an additional solvent to resolve the layer separation, which is much more economically effective.

An embodiment relates to a carbon dioxide absorbent containing an ionic material containing a cyclic ammonium cation and a hydroxide anion. The carbon dioxide absorbent according to an embodiment contains a hydroxide anion having a small molecular weight and high basicity, such that absorption performance per unit volume of the absorbent may be effectively improved. Further, the carbon dioxide absorbent according to an embodiment is soluble in water and thus may not cause layer separation problems.

Hereinabove, although an embodiment has been described in detail by the examples and the experimental examples, the scope of the embodiment is not limited to a specific example and should be construed by the appended claims.

What is claimed is:

1. A carbon dioxide absorbent comprising an ionic material containing a cyclic ammonium cation represented by the following Chemical Formula 1 and a hydroxide anion: 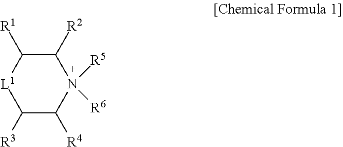
wherein
R¹ to R⁴ are each independently —H, a C₁₋₂₀ alkyl group, a C₁₋₂₀ alkoxy group, a C₁₋₁₀ alkoxy C₁₋₁₀ alkyl group, a C₅₋₂₀ cycloalkyl group, or a 5-membered to 20-membered heterocycloalkyl group;
R⁵ and R⁶ are each independently —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group;
L¹ is a single bond, —O—, —NR⁷—, or a C₁₋₈ alkylene group;
R⁷ is —H or a C₁₋₁₀ alkyl group, or R⁷ may be bonded to R⁵ to form a ring; and
the C₁₋₂₀ alkyl group, the C₁₋₂₀ alkoxy group, the C₁₋₁₀ alkoxy C₁₋₁₀ alkyl group, the C₅₋₂₀ cycloalkyl group, and the 5-membered to 20-membered heterocycloalkyl group of R¹ to R⁷ may each independently be substituted with a halogen group, —OH, —NH₂, or —NO₂.

2. The carbon dioxide absorbent of claim 1, wherein in Chemical Formula 1,
R¹ to R⁴ are each independently —H, a C₁₋₁₀ alkyl group, a C₁₋₁₀ alkoxy group, a C₁₋₅ alkoxy C₁₋₅ alkyl group, a C₅₋₁₀ cycloalkyl group, or a 5-membered to 10-membered heterocycloalkyl group;
R⁵ and R⁶ are each independently —H, a C₁₋₁₀ alkyl group, a C₁₋₅ alkoxy C₁₋₅ alkyl group, a C₅₋₁₀ cycloalkyl group, or a 5-membered to 10-membered heterocycloalkyl group;
L¹ is a single bond, —O—, —NR⁷—, or a C₁₋₅ alkylene group;
R⁷ is —H or a C₁₋₅ alkyl group, or R⁷ may be bonded to R⁵ to form a ring; and
the C₁₋₁₀ alkyl group, the C₁₋₁₀ alkoxy group, the C₁₋₅ alkoxy C₁₋₅ alkyl group, the C₅₋₁₀ cycloalkyl group, and the 5-membered to 10-membered heterocycloalkyl group of R¹ to R⁷ may each independently be substituted with a halogen group, —OH, —NH₂, or —NO₂.

3. The carbon dioxide absorbent of claim 1, wherein the cyclic ammonium cation is represented by the following Chemical Formula 2: 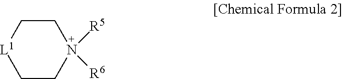
wherein
R⁵ and R⁶ are each independently —H, a C₁₋₂₀ alkyl group, a C₁₋₁₀ alkoxy C₁₋₁₀ alkyl group, a C₅₋₂₀ cycloalkyl group, or a 5-membered to 20-membered heterocycloalkyl group;
L¹ is a single bond, —O—, —NR⁷—, or a C₁₋₈ alkylene group;
R⁷ is —H or a C₁₋₁₀ alkyl group, or R⁷ may be bonded to R⁵ to form a ring; and
the C₁₋₁₀ alkyl group, the C₁₋₂₀ alkyl group, the C₁₋₁₀ alkoxy C₁₋₁₀ alkyl group, the C₅₋₂₀ cycloalkyl group, and the 5-membered to 20-membered heterocycloalkyl group of R⁵ to R⁷ may each independently be substituted with a halogen group, —OH, —NH₂, or —NO₂.

4. The carbon dioxide absorbent of claim 3, wherein in Chemical Formula 2,
R⁵ and R⁶ are each independently a C₁₋₁₀ alkyl group, a C₁₋₅ alkoxy C₁₋₅ alkyl group, a C₅₋₁₀ cycloalkyl group, or a 5-membered to 10-membered heterocycloalkyl group;
L¹ is a single bond, —O—, —NR⁷—, or a C₁₋₈ alkylene group;
R⁷ is —H or a C₁₋₅ alkyl group; and
the C₁₋₁₀ alkyl group, the C₁₋₅ alkoxy C₁₋₅ alkyl group, the C₅₋₁₀ cycloalkyl group, and the 5-membered to 10-membered heterocycloalkyl group of R⁵ to R⁷ may each independently be substituted with —OH, —NH₂, or —NO₂.

5. The carbon dioxide absorbent of claim 3, wherein in Chemical Formula 2,
R⁵ and R⁶ are each independently a C₁₋₅ alkyl group or a C₁₋₃ alkoxy C₁₋₃ alkyl group;
L¹ is —O— or a methylene group; and
the C₁₋₅ alkyl group and the C₁₋₃ alkoxy C₁₋₃ alkyl group of R⁵ and R⁶ may each independently be substituted with —OH.

6. The carbon dioxide absorbent of claim 1, wherein the cyclic ammonium cation is one selected from the group consisting of the following compounds:

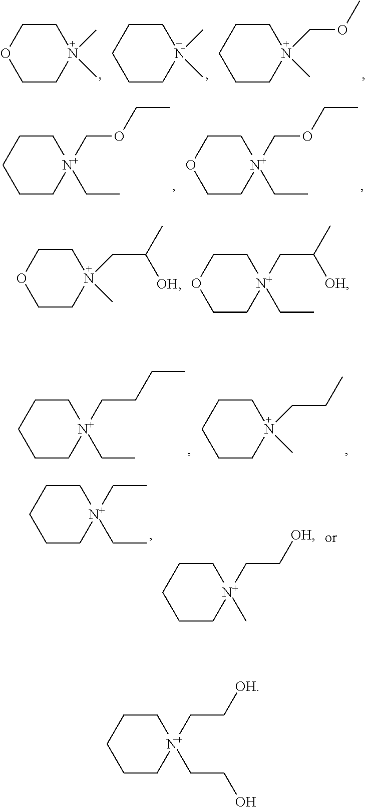

7. The carbon dioxide absorbent of claim 1, further comprising water.

8. The carbon dioxide absorbent of claim 7, further comprising one or more solvents other than the water.

9. The carbon dioxide absorbent of claim 8, wherein the solvent contains an amine-based compound.

10. The carbon dioxide absorbent of claim 9, wherein the amine-based compound includes one or more selected from the group consisting of monoethanolamine (MEA), N-methyldiethanolamine (MDEA), diethanolamine (DEA), triethanolamine (TEA), 2-amino-2-methyl-1-propanol (AMP), and piperazine (PZ).

11. The carbon dioxide absorbent of claim 1, wherein the ionic material is contained in an amount of 5 wt % to 50 wt % with respect to a total weight of the carbon dioxide absorbent.

12. The carbon dioxide absorbent of claim 7, wherein the water is contained in an amount of 30 wt % to 90 wt % with respect to a total weight of the carbon dioxide absorbent.

13. The carbon dioxide absorbent of claim 9, wherein the amine-based compound is contained in an amount of 10 wt % to 50 wt % with respect to a total weight of the carbon dioxide absorbent.

14. A carbon dioxide separation method comprising bringing the carbon dioxide absorbent of claim 1 into contact with a mixture containing carbon dioxide under a temperature condition of 20° C. to 80° C.

15. The carbon dioxide separation method of claim 14, further comprising desorbing carbon dioxide attached to the carbon dioxide absorbent by performing a heat treatment on the carbon dioxide absorbent under a temperature condition of 70° C. to 150° C. for 30 minutes to 250 minutes.

16. The carbon dioxide separation method of claim 15, wherein bringing the carbon dioxide absorbent into contact with the mixture and desorbing the carbon dioxide are sequentially repeated to continuously separate the carbon dioxide.

17. A carbon dioxide separation method comprising:
contacting a mixture containing carbon dioxide with a carbon dioxide absorbent;
absorbing the carbon dioxide into the carbon dioxide absorbent;
desorbing the absorbed carbon dioxide attached to the carbon dioxide absorbent,
wherein the absorbing and desorbing operations are performed sequentially and repeatedly to separate the carbon dioxide from the mixture,
wherein the carbon dioxide absorbent includes an ionic material containing a cyclic ammonium cation and a hydroxide anion having a small molecular weight and high basicity, and
wherein the carbon dioxide absorbent is soluble in water.
